(19) United States
(12) Patent Application Publication
(10) Pub. No.: US 2014/0203661 A1
(43) Pub. Date: Jul. 24, 2014

(54) INDUCTIVE POWER RECEIVER HAVING DUAL MODE CONNECTOR FOR PORTABLE ELECTRICAL DEVICES

(71) Applicant: POWERMAT TECHNOLOGIES, LTD., NEVE ILAN (IL)

(72) Inventors: Yaniv DAYAN, Ashdod (IL); Amir HASSON, Kfar Saba (IL); Moti KDOSHIM, Modiin (IL)

(73) Assignee: POWERMAT TECHNOLOGIES, LTD., NEVE ILAN (IL)

(21) Appl. No.: 14/159,885

(22) Filed: Jan. 21, 2014

Related U.S. Application Data
(60) Provisional application No. 61/754,699, filed on Jan. 21, 2013.

(51) Int. Cl. H01F 38/14

(52) U.S. Cl. CPC H01F 38/14
USPC 307/104

(57) ABSTRACT

A multi-mode power transfer providing system for an electrical device adapted to support dual-mode operable to receive power wirelessly using hermaphrodite power connector coupled with data exchange functionality. The multi-mode power transfer providing system may comprise a wired power connector; and a wireless power receiver unit comprising a wireless power receiving element; and a selection control switch, wherein the selection control switch is configured to switch between a wired power transfer mode wherein the wired power connector is electrically connected to the electrical device, and a wireless power transfer mode wherein the wireless power receiver is electrically connected to the electrical device.

### CROSS-REFERENCE TO RELATED APPLICATIONS

This application claims the benefit of U.S. provisional application Ser. No. 61/754,699 filed Jan. 21, 2013, the disclosure of which is hereby incorporated in its entirety by reference herein.

### FIELD OF THE INVENTION

The present invention is directed to providing power to electrical devices. In particular the present invention relates to portable electrical devices adapted to support dual-mode operable to receive power wirelessly using a power connector coupled supporting data exchange functionality.

### BACKGROUND

Mobile communication devices, such as computers, cellular telephones and the like, are typically powered by power cells, i.e. rechargeable electrochemical cells often also referred to as batteries. In order to recharge the power cells such devices are generally provided with a charger unit for connecting to a power jack socket on the device which is wired to contacts with the terminals of the cells. The charger itself usually consists of a plug box containing a step-down transformer and an AC-DC converter or rectifier which is wired to a connecting plug. When in use, the plug box is plugged into a 120V or 240V mains socket and the connecting plug is coupled to the device. The wire trailing between the device and the plug box can be unsightly. Moreover, if the trailing wire is snagged or jerked the wire and connectors may be damaged, as indeed could be the socket or the wall. Furthermore, the device may be pulled to the ground.

Chargers are bulky items to carry around. Therefore most users of compact portable equipment such as cell phones and the like do not carry chargers with them, but prefer to rely upon periodic charging, perhaps overnight. Often users rely on even more infrequent charging. As a result cells often run down at inconvenient times when no charger is available.

Inductive battery charger systems are known such as the system described in U.S. Pat. No. 7,164,255 to Hui incorporated herein by reference. In Hui's system a planar inductive battery charging system is designed to enable electronic devices to be recharged. The system includes a planar charging module having a charging surface on which a device to be recharged is placed. Within the charging module, and parallel to the charging surface, is at least one, and preferably an array of primary windings that couple energy inductively to a secondary winding within the device to be recharged. The invention also provides secondary modules that allow the system to be used with conventional electronic devices not formed with secondary windings.

Hui's system provides an inductive charging platform for mobile telephones. However, unless the device to be charged has an integral secondary winding coil, it is necessary to carry a bulky secondary module with which to use the platform. Hui's system does not describe any convenient means for providing secondary windings for conventional devices.

There is therefore a need for a convenient power supply for a mobile communication device and particularly for a charger, which may be conveniently retrofitted to conventional devices.

### SUMMARY

It is an aim of the invention to provide a multi-mode power transfer providing system for an electrical device.

In accordance with a first embodiment, the present invention is directed to providing a multi-mode power transfer providing system for an electrical device comprising: the electrical device; a wired power connector; and a wireless power receiver unit comprising: a wireless power receiving element; and a selection control switch, wherein the selection control switch is configured to switch between: a wired power transfer mode wherein the wired power connector is electrically connected to the electrical device, and a wireless power transfer mode wherein the wireless power receiver is electrically connected to the electrical device.

Where appropriate, wherein the wireless power receiver of the multi-mode power transfer system comprises a secondary inductor, for inductively coupling with a primary inductor wired to a power supply.

In various embodiments, wherein the wireless power receiver unit of the multi-mode power transfer system is connected to the electrical device via a first plug-and-socket connector selected from a group consisting of: a mini-USB connector arrangement, a micro-USB connector arrangement, an Apple lightning connector arrangement, an 8-pin connector. Further, wherein the wired power connector of the multi-mode power transfer system comprises a second plug-and-socket connector selected from a group consisting of: a mini-USB connector arrangement, a micro-USB connector arrangement, an Apple lightning connector arrangement, an 8-pin connector arrangement, 30-pin Apple connector, Thunderbolt connector and a DC jack.

In preferred embodiments of the invention, wherein the wired power connector of the multi-mode power transfer system is further operable to connect with a data exchange mechanism such that data is exchangeable between an external device and the electrical device.

Optionally, the data exchange mechanism is configured to use a short range radio frequency link, said radio frequency link is selected from a group consisting of: Wi-Fi, Bluetooth, Near Field Communication, Zigbee and combinations thereof.

Optionally, the data exchange mechanism uses a plug-and socket connector selected from a group consisting of a mini-USB connector, a micro-USB connector interface and vendor proprietary connector.

It is a further aim of the invention to provide a wireless power receiver unit for connecting to an electrical device, the wireless power receiver unit comprising: a wireless power receiving element; a first connector configured to connect with a power connector of the electrical device; a second connector configured to connect with a connector of a wired external power source; and a selection control switch; wherein the selection control switch is configured to switch between: a wired power transfer mode wherein the first connector is electrically connected to the second connector, and a wireless power transfer mode wherein the first connector is connected to the wireless power receiving element.

In various embodiments, wherein the wireless power receiving element comprises a secondary inductor, for inductively coupling with a primary inductor wired to a power supply.

As appropriate, wherein the first connector of the wireless power receiver unit comprises a male plug connector configured to connect with a female power connector socket connector of the electrical device. Further, the second connector of the wireless power receiver unit comprises a female socket connector configured to connect with a male plug connector socket connector of the wired external power source.

Optionally, the switching of the wireless power receiver unit is performed automatically.

Optionally, the switching of the wireless power receiver unit is performed manually.

In various embodiments, the first connector of the wireless power receiver unit is selected from a group consisting of: a mini-USB connector arrangement, a micro-USB connector arrangement, an Apple lightning connector arrangement, an 8-pin connector. Further, the second of the wireless power receiver unit connector is selected from a group consisting of: a mini-USB connector arrangement, a micro-USB connector arrangement, an Apple lightning connector arrangement, an 8-pin connector arrangement, a 30-pin Apple connector, Thunderbolt connector and a DC jack.

Optionally, the wireless power receiver unit, wherein the wired external power source is a wired charger powered by a power supply, the power supply is selected from a group consisting of mains power supply, a host computer and a vehicle power outlet.

Optionally, the wireless power receiver unit, wherein the second connector is further connectable to a USB plug for coupling to a USB power socket such that the electrochemical cell is selectably chargeable and power is drawn from the USB power socket or used for data exchanging between an external device and said electrical device.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic illustration of an inductive power providing means for powering a computer, in accordance with one embodiment of the present invention;

FIG. 2 is a schematic illustration of a computer provided with a secondary inductive coil incorporated within the base thereof, for inductively powering the computer by bringing into proximity with a power supplying inductive coil, according to another embodiment of the invention;

FIG. 3 shows the jack sockets of a portable computer according to a further embodiment of the invention for coupling to an electricity mains power source via an inductive couple or via a conventional power supply;

FIG. 4 is a schematic illustration of a computer carrying case according to another embodiment of the invention with an inductive power coil built into the base thereof;

FIG. 5 is a schematic illustration of another embodiment of the computer carrying case having an inductive power coil built into the handle thereof;

FIG. 6 is a schematic illustration of still another embodiment of the computer carrying case having an inductive power coil built into the shoulder strap thereof;

FIGS. 7A and 7B are schematic illustrations of a retrofittable carrying handle for a portable computer with a built-in inductive power coil according to further embodiments of the invention;

FIG. 8 is a schematic illustration of a fashion-tag attachment with a built-in inductive power coil in accordance with still another embodiment of the invention;

FIGS. 9A and 9B are schematic illustrations of a computer provided with another embodiment of the invention including a retractable secondary inductive coil attachment;

FIG. 10 is a schematic illustration of an inductive charger for a mobile communication device of a further embodiment of the invention;

FIGS. 11A and 11B are schematic illustrations of a mobile communication device with an inductive charger built into the skin thereof according to another embodiment of the invention;

FIG. 12A is a schematic illustration of a self-adhesive inductive charger for a mobile communication device adhered to a power cell according to another embodiment of the invention;

FIG. 12B is a schematic illustration of how the self-adhesive inductive charger of FIG. 12a may be used to charge cells;

FIG. 13A is a block diagram representing the main components of an inductive charging system including an induction enabled power receiver;

FIG. 13B is a block diagram representing the main components of a dual-mode inductive and wired charging system;

FIG. 14 is a schematic illustration of an inductive charger of another embodiment of the invention having a hermaphrodite power connector;

FIGS. 15A-C are schematic illustrations of a protective case according to a further embodiment of the invention with a built-in an inductive charger for a mobile communication device;

FIG. 16 is a block diagram representing selected elements of another embodiment of a hermaphrodite power connector structure supporting dual inductive charging functionality;

FIG. 17 is a schematic illustration of a possible embodiment of Micro USB connection to an iPhone, enabling data transfer functionality; and

FIG. 18 is a schematic illustration of a Micro USB connector pins, for reference only.

FIG. 19 is a schematic illustration of a mobile communication device with an inductive charger built into a fashion tag;

FIG. 20 is a schematic illustration of an inductive charger for a mobile communication device with a combined data connector;

FIG. 21 is a block diagram showing the main elements of a charger for an audio device incorporated into an earphone unit in accordance with another embodiment of the invention;

FIG. 22A is a schematic diagram of a charger for an audio device according to another embodiment of the invention, wherein the voice coil of a speaker is wired to the power cell of the audio device and is inductively coupleable to a primary inductor;

FIG. 22B is a block diagram showing the main elements of a switching unit for connecting the charger of FIG. 22A to an audio device;

FIG. 23A is a schematic diagram of another embodiment of the charger for an audio device wherein an induction loop is incorporated into a neck support of the earphone unit;

FIG. 23B is a schematic diagram of still another embodiment of the charger for an audio device wherein an induction loop is formed by connecting contact-terminals incorporated into the earphone cables;

FIG. 23C is a schematic representation of an embodiment of the charger for an audio device wherein an inductive core extends through an internal secondary coil and into the earphone unit for coupling with an external primary inductor;

FIG. 24 is a flowchart showing a possible method for charging the internal power cell of an audio device;

FIGS. 25A and 25B are block diagrams schematically representing an inductive charger according a further embodiment of the invention in charging and driving modes respectively;

FIG. 26A is a schematic representation of another embodiment of the inductive charger being charged by a primary coil;

FIG. 26B is a schematic representation of the inductive charger of FIG. 26A being used to charge a mobile telephone wired to a secondary coil;

FIG. 27A is a schematic representation of a mobile computer being powered by a primary coil via an integral inductive coil according to another embodiment of the invention, and

FIG. 27B is a schematic representation of a mobile telephone being charged by the inductive coil of FIG. 27A.

### DETAILED DESCRIPTION

Aspects of the present disclosure relate to wireless power transmission systems. In particular the embodiments relate to a hermaphrodite power connector for connecting and switching a receiver of a wireless power transfer system to a chargeable device supporting multi-mode functionality for example of inductive power transmission, data exchange, and recharging from a conductive power supply source. The system may enable switching between wireless power charging and conductive charging. The system may be operable to assign priority to one or other of the charging modes. Furthermore, the system may optionally allow data exchange via the conductive connector alongside charging from one or other of the charging modes.

Embodiments described herein disclose a hermaphrodite power connector as part of an inductive power transfer system with a control switch configured to automatically select power transfer mode according to the type of power source. A conductive power supply mode may use an electrical line or a connection to a computing device via a data or power cable such as a USB cable. This may represent one possible power supply mode while a wireless power supply such as an inductive component may provide an alternative power supply mode.

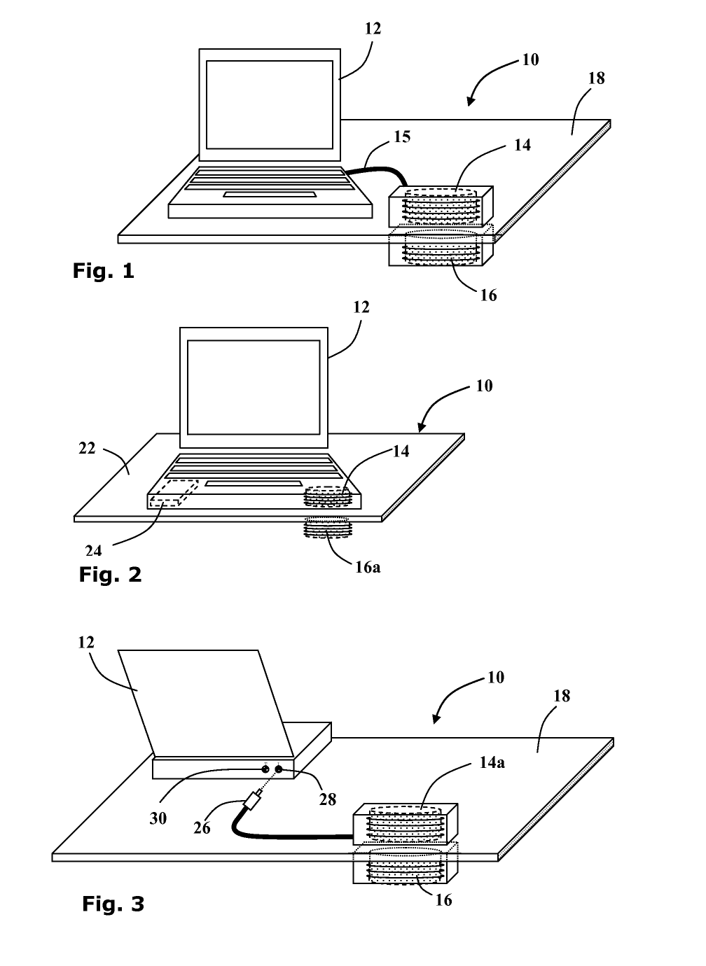

Reference is now made to FIG. 1, showing a power providing means 10 for a portable computer 12 consisting of a secondary inductor 14 wired to the portable computer by a connecting wire 15 that is typically a two stripe multi-fiber insulated wire, such as used for providing power to portable computers via a transformer.

The secondary inductor 14 is essentially a coil which can be brought into proximity with a primary inductor 16 which is essentially another coil hardwired to a mains power supply 18. The primary coil 16 and secondary coil 14 thus form an inductive power couple 20, allowing power to be provided to the portable computer 12. The primary coil 16 may be situated in the table top 18 of a conference table, for example. By supplying power inductively in this manner, trailing wires may be avoided, providing a neater, safer and more flexible work environment.

It will be appreciated that, although a system for providing power to a portable computer is described herein, the power providing means 10 may also be applicable to the provision of power to other electrical devices such as a desktop computer, handheld computer, vehicle mounted computer or the like. Power providing means 10 may also be used by other portable systems such as hand-held DVD players, projectors, hand-held televisions, digital picture frames or sound systems for example.

As shown in FIG. 2, in an embodiment of the invention, the secondary coil 14 may be integral to the portable computer 12, being built into the base thereof, under the keyboard. Positioning the computer 12 over a primary coil 16a in a work-surface 22, for example, enables power to be provided thereto, without trailing wires. The power may be used to recharge the electrochemical power pack (battery) 24 or to power the portable computer 12.

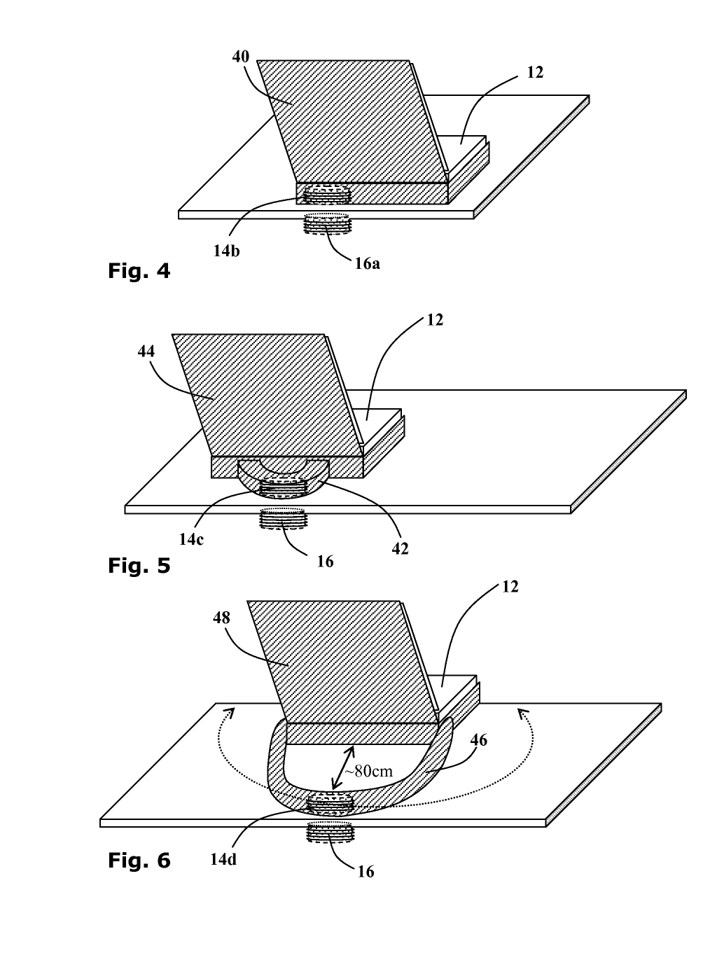

As shown in FIG. 3, in another embodiment of the invention, the secondary coil 14a may be coupled to a portable computer 12 designed for optional power provision in this manner, via a jack 26 that is plugged into a dedicated jack socket 28 designed for coupling the secondary coil 14a. The dedicated jack socket 28 is separate from the power supply jack socket 30 supplied for coupling to a power supply (not shown) of the type consisting of a transformer for plugging into a power mains socket that is typically provided. The dedicated jack plug 26 and jack socket 28 may usefully be physically different from power supply jack socket 30 and jack plug (not shown), to prevent misconnection. Similarly, the inductive and transformer sockets 28, 30 are preferably appropriately labeled, perhaps with letters I and T for inductive and transformer, to prevent confusion.

However, since the purpose of inductive coupling is to avoid and replace transformer coupling, in preferred embodiments, the secondary coil 14a is connected to the portable computer 12 via the power jack socket 30 designed for coupling to a mains via a power supply of the transformer type. In this manner, existing portable computers may be retrofitted with a secondary coil 14a for inductive powering.

Power may alternatively be provided to the portable computer 12 via connecting points designed for coupling to a rechargeable electrochemical power pack within the housing for the power pack.

The secondary coil 14a may be provided as a sort of puck on a wire that can be positioned over an access point in a surface where a primary coil 16 is provided.

Alternatively however, usefully, to provide a neat solution, to eliminate trailing wires, recoiling such wires and to make disconnecting simpler, as shown in FIG. 4 the secondary coil 14b is preferably incorporated into an accessory that has additional functionality. For example, it may be built into the side of a carrying case 40 or skin provided for carrying the portable computer 12. In one preferred embodiment as shown in FIG. 5 the secondary coil 14c is built into the handle 42 of a carrying case 44.

As shown in FIG. 6, in one embodiment, the secondary coil 14d is built into the shoulder strap 46 of a carrying case 48 which being flexible, gives more flexibility to the user, in that the computer 12 can be left in its case, and situated anywhere within a radius of about 80 cm from a “power-spot” where a primary coil 16 is situated.

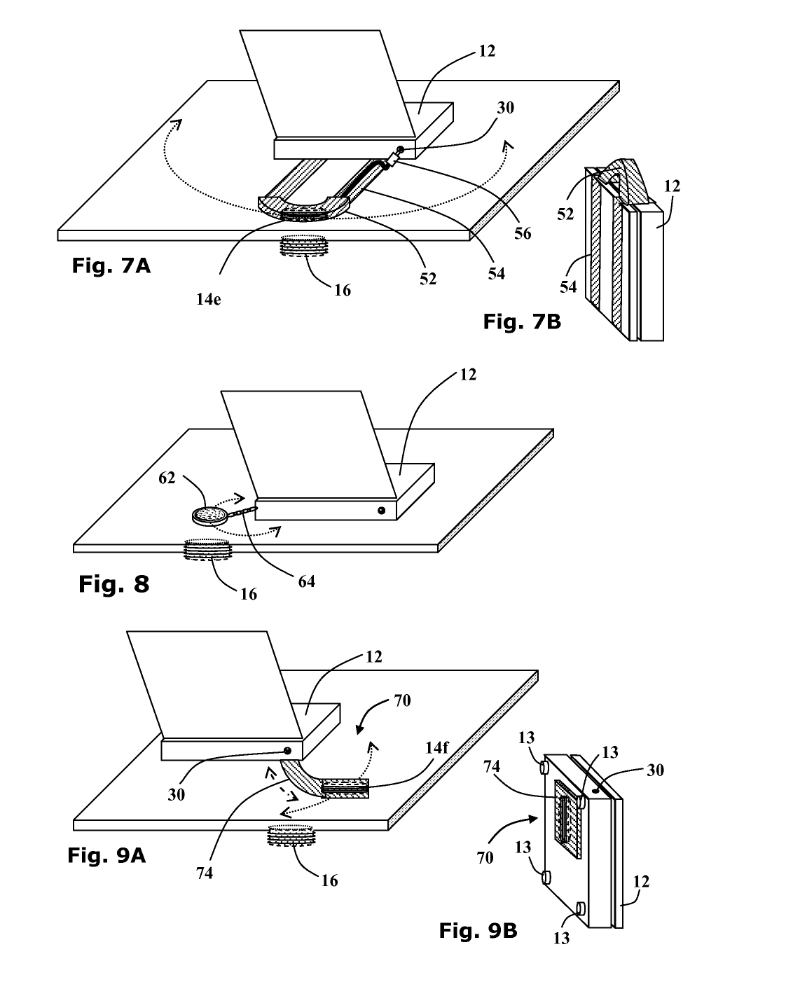

With reference now to FIGS. 7a and 7b, a retrofittable carrying handle 52 for a computer 12 is shown. The handle 52 is attached to the computer by straps 54 and incorporates a built-in inductive power coil 14e electrically coupled to the computer via a power plug 56 which plugs into the power jack 30 of the computer 12.

Whilst the computer 12 is being carried, the straps 54 surround and support the computer 12 as shown in FIG. 7B. However, as shown in FIG. 7A, when the computer 12 is laid down and in use, the support straps 54 are opened allowing the inductive power coil 14e to be coupled to a primary coil 16 situated anywhere within their radius.

Alternatively, with reference to FIG. 8, the inductive power coil 14 may be concealed inside a fashion-tag 62 attached to the computer 12 for example by a connecting chain 64 or the like. Thus, by aligning the fashion-tag 62 to a power spot, the computer may draw power from a primary coil 16.

In a further embodiment, a retractable secondary inductive coil attachment 70 may be retrofitted to a portable computer 12, as shown in FIGS. 9a and 9b. The secondary inductive coil 14f is held in a tongue 74 mounted upon the base of the computer 12 and when the computer 12 is in use as shown in FIG. 9A, the tongue 74 may be extended so that the secondary coil 14f may couple with a power spot 16 within its radius.

When the portable computer is stowed, as in FIG. 9B, tongue 74 may be retracted. Preferably, the thickness of the secondary inductive coil attachment 70 is less than the height of the feet 13 of the computer 12 so that the attachment 70 does not prevent the computer 12 lying flat along a table top.

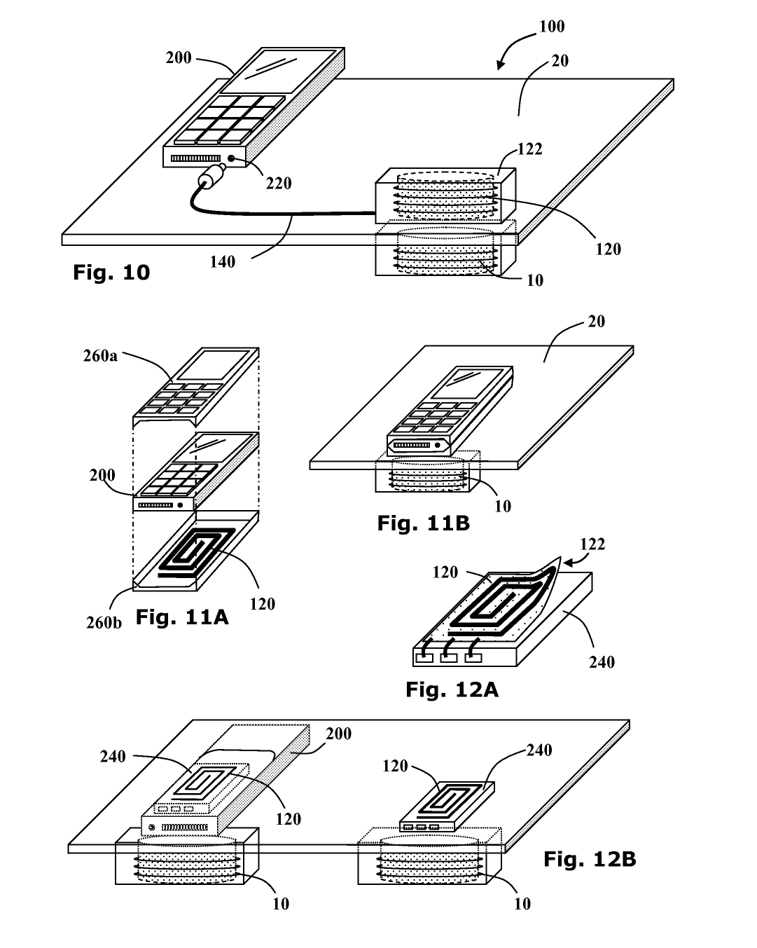

Referring now to FIG. 10, an inductive charger 100 is shown for charging the power cells of a mobile communication device 200 such as mobile telephone, personal digital assistant (PDA), camera or the like, indeed many mobile devices include all of these functions. The charger 100 consists of a secondary coil 120 wired to the mobile communication device 200 typically via a power jack socket 220 of by a connecting wire 140—typically a two stripe multi-fiber insulating wire, such as used for electrically connecting a power source to a mobile communication device via a transformer.

The secondary coil 120 can be brought into proximity with a primary coil 10 hardwired to a mains power supply, to form an inductive power couple, allowing power to be provided to recharge the cells 240 (FIGS. 12A and 12B) of the mobile communication device 200. The primary coil 10 may be situated in the table top 20 of a conference table, for example, thereby allowing a phone 0 to be recharged thereby. By inductively recharging in this manner, trailing wires may be avoided or at least minimized. The secondary coil 120 may be provided for example as a sort of puck 122 on a wire that can be positioned over an access point in a surface where a primary coil 10 is provided. Alternatively the secondary coil 120 may be built into an accessory of the telephone 200.

Over the years, mobile telephones have become a fashion item and various fashionable accessories are often sold for use therewith. Such accessories include for example, replacement phone skins, protective cases, belt clips, small ornamental pendants, sometimes known as “mobile danglers” and the like. Some such accessories are merely decorative, others perform secondary functions such as providing added protection to the device, or more convenient ways to carry the device. The secondary coil 120 of the current invention may be incorporated into any of these.

As shown in FIG. 11A, according an embodiment of the invention the secondary coil 120 may be built into the skin or casing 260a, 260b of the mobile communication device. Positioning the mobile communication device over a primary coil 10, as shown in FIG. 11B, at an access point in a work-surface 20, for example, enables power to be provided to the charger thereby charging the power cells 240 of the mobile communication device 200 without trailing wires.

The charger may be connected directly to the terminals of the power cells. Alternatively the charger may be connected to the power cells via the power jack socket 220 of the mobile communication device 200.

According to another embodiment, shown in FIG. 12A, the secondary coil 120 may be provided with an adhesive surface 122 so that the coil 120 may be adhered directly onto the power cells 240 of a mobile telecommunication device 200 in conductive contact with the terminals of the power cells. When power cells 240 are positioned such that the secondary coil 120 forms as inductive couple with a primary coil 10 the cells 240 may be recharged. As shown in FIG. 12B, it is noted that in this embodiment, the cells 240 are recharged directly from the secondary coil 120 so the cells 240 do not need to be connected to the device in order for them to be charged.

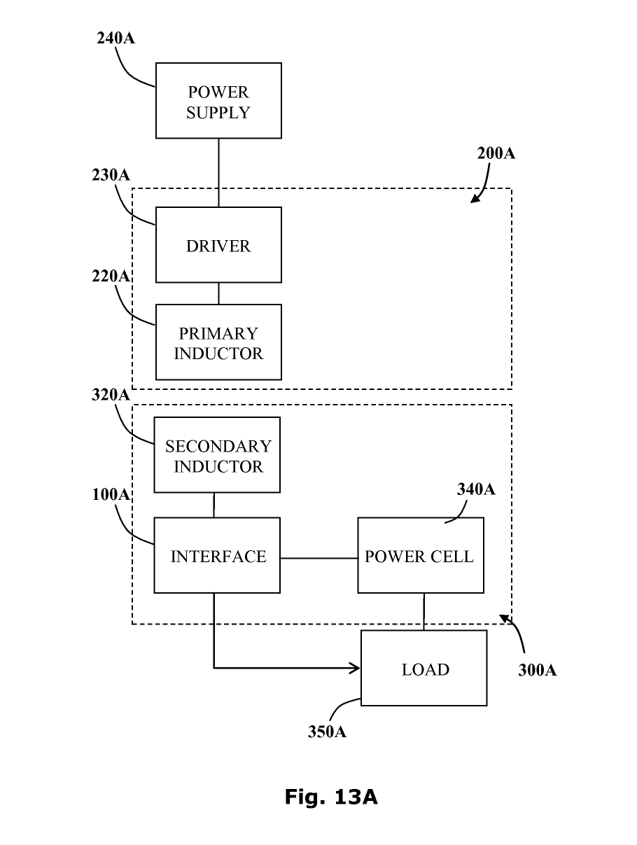

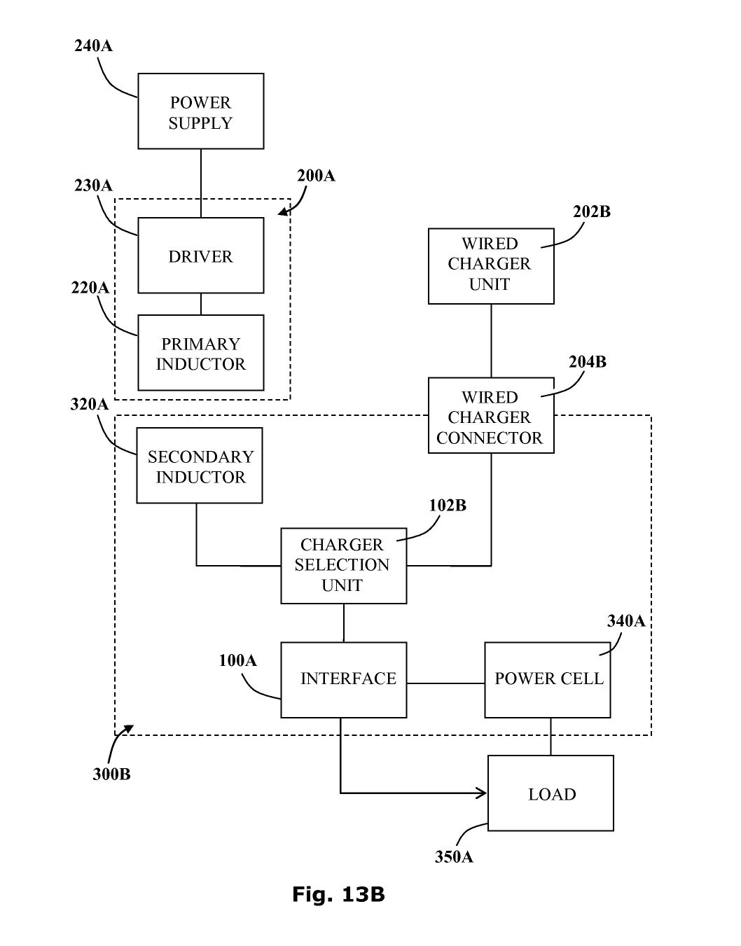

It is particularly noted that FIG. 13A represents a single-mode system in which an inductive enabled power receiver 300A is configured to receive power wirelessly.

FIG. 13A and FIG. 13B provide an overview of possible arrangements of inductive power transfer systems, but the disclosure is not limited to these configurations. FIG. 13A provides a block diagram of single-mode functionality, where the inductive enabled power receiver is configured to receive power inductively and is presented here in order to better understand the particular feature of the current disclosure.

FIG. 13B provides an alternative embodiment representing a dual-mode power receiver charging which is a particular feature of the current disclosure. The receiver is operable to receive power in wireless mode, conductive mode and may be further operable to enable data exchange.

It is noted, that the current disclosure may provide an operable mechanism to provide dual-mode of rechargeable power for the electrochemical cell using a hermaphrodite power connector of a wireless charging system which may be combined with an integrated or separate operable data exchange mechanism.

It is further noted that the system of the current disclosure may be useful for combination with electrical devices having dedicated power adaptors.

Optionally, a dual operable data exchange mechanism may be applied. Practically, an accessory comprises a USB plug for coupling to a USB power socket, such as a USB port of a computer, such that the electrochemical cell is selectably chargeable by power drawn from the USB power socket or may be used for data exchange. Typically, the USB plug is wired to a data jack socket of the electrical device such that data is exchangeable between the computer and the mobile communication device. Additionally or alternatively, data exchange functionality may be added using a short range radio frequency link such as Wi-Fi, Bluetooth, NFC, Zigbee or the like with which communication devices may be equipped.

Reference is now made to FIG. 13A which shows a block diagram representing the main components of a possible wireless charging system including a wireless power outlet 200A and a wireless charging enabled power receiver 300A.

The wireless power outlet 200A includes a primary inductor 220A which is wired, via a driving unit 230A, to a power supply 240A, such as the mains or a vehicle battery, for example. The driving unit 230A is configured to provide an oscillating driving voltage to the primary inductor 220A. As will be described below, in certain embodiments, the oscillating driving voltage is selected to be at a frequency other than the resonant frequency of the inductive coupling system.

The power receiver 300A is configured to power an electrical load 350A and incorporates the secondary inductor 320A, the electrochemical cell 340A and the interface module 100A. In certain embodiments, the secondary inductor 320A and the interface module 100 may be additionally operable to power the electric load 350A directly without charging the electrochemical cell.

It is a particular feature of embodiments of the interface module 100A that it may be operable to charge the power receiver 300A or control the transfer of power to the load 350A and to manage communication between the power receiver 300A and the inductive power outlet 200A. Accordingly, in various embodiments the interface module 100A is configured to perform a variety of functions including, but not limited by, the following:

rectification of alternating current (AC) generated by the secondary inductor 320A into direct current (DC) for charging the electrochemical cell 340A; regulating the charging voltage across the electrochemical cell 340A; regulating the charging current to the electrochemical cell 340A; regulating the temperature of the electrochemical cell 340A for example by controlling the charging current; sending feedback signals to the primary inductor; controlling the energy transfer from inductive power system 200A; identifying the power receiver 300A for the inductive power system; indicating that the power receiver 300A is fully charged, possibly via an charge indication light; automatically terminating the charging process; automatically disconnecting the electrochemical cell 340A from the electric load 350A; monitoring charge status; monitoring voltage across the power pack; detecting faults; prevention of deep discharge of the electromechanical cell, and synchronization/communication with the battery pack electronics, and data transfer.

It is noted that over-charging may be damaging for many electrochemical cells. Therefore charging of the electrochemical cell 340A may be automatically terminated when the target voltage has been reached or the charging current has dropped below a predetermined level. Additionally, to prevent over-discharge, a circuit breaker may be provided to disconnect the electrochemical cell from the load 350A when a lower limit is reached.

Because excessive current can damage the cell 340A and may be indicative of a short circuit or other fault, the interface circuit 100A may be configured to monitor charge or discharge current. Alongside the current monitor, the interface circuit 100A may further include a current limiter for reducing or cutting-off large currents in excess of the rated charge current, for example currents above 1.2 ampere or so, which may be damaging to the battery. Current monitoring and limiting functionality may be provided by means of a current sense resistor. It is further noted that, in embodiments in which a protection circuit disconnects the electrochemical cell when fully charged, the interface module may be further configured to ensure that the electrochemical cell is fully charged by periodically reactivating the charge current. Accordingly in some embodiments, once the charging current is cut off, the interface circuit 100A is configured to send a signal to deactivate a primary inductor 220A coupled to the secondary inductor 320A of the power receiver 300A. Where required, a periodic refresh charging procedure may be activated after set intervals of, say, two hours or so. It is noted that current limiting may be of particular utility in cases of failure in the phone/cell power management.

It is noted that the charging process may be temperature dependent. High charging temperatures may damage the electrochemical cell and low temperatures may result in limited charging. Because of this temperature dependency, the interface circuit 100A may be further configured to monitor and regulate the power pack temperature during the charging. Optionally, a temperature sensor, such as a thermistor, thermocouple, digital sensors or the like, may be provided to monitor charging temperature and logic applied to limit charging current in order to keep the temperature within a preferred range. Notably, particular embodiments may be configured to operate within the internal temperature range from say minus ten degrees Celsius to forty-five degrees Celsius (263 Kelvin to 328 Kelvin).

In single-mode embodiments, such as described hereinabove with reference to FIG. 13A, the inductive enabled power receiver 300A is configured only to receive power inductively.

Referring now to FIG. 13B representing the particular continuation functionality of the current disclosure. Whereas, the possible wireless charging system described hereinbefore (see FIG. 13A) represents a single-mode embodiment, the current representation provides an alternative dual-mode embodiment.

FIG. 13B represents a dual-mode wireless power receiver 300B which is further configured to receive power from a wired charger unit 202B where required, in addition to the power possibly received from the secondary inductor 320A. It will be appreciated that the dual-mode inductive power receiver 300B may be useful in combination with electrical devices which have dedicated powering adaptors.

The wired charger unit 202B may be connected to the dual-mode inductive power receiver 300B via a plug-and-socket connector, such as a mini-USB connector arrangement, a micro-USB connector arrangement, an Apple lightning connector arrangement, an 8-pin connector arrangement, 30-pin Apple connector, Thunderbolt connector, DC jack or the like as known in the art.

The dual-mode inductive power receiver 300B includes a charger selection unit 102B and a wired charger connector 204B receiving power from the wire charger unit 202B. The charger selection unit 102B is configured to automatically switch between wired and inductive charging modes.

Optionally, the charger selection unit 102B may be configured to disconnect one charger type in the presence of the other. For example when a wired charger 202B is connected, the charger selection unit 102B may be configured to disconnect the secondary inductor 320A in order to prevent double charging. In other embodiments the charger selection unit 102B may be configured to disconnect the wired charger connector 204B when an inductive charger 200A is coupled to the inductive power receiver 300B. Alternatively, in still other embodiments, the charger selection unit 102B may be configured to control simultaneous charging using a combination of inductive and wired charging modes.

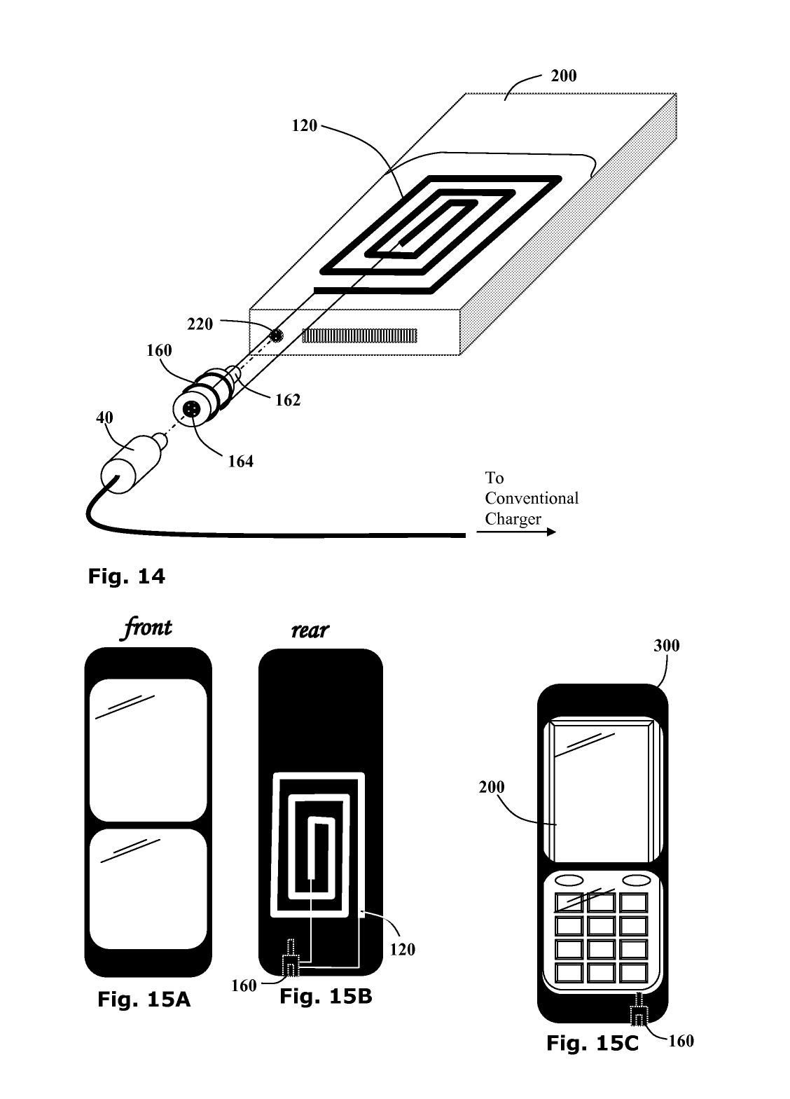

Referring now to FIG. 14, which is a schematic illustration of an inductive charger of another embodiment of the invention having a hermaphrodite power connector. The hermaphrodite power connector 160 includes may be connected to a mobile communication device or tablet 200A via a first plug-and-socket connector, such as a mini-USB connector arrangement, a micro-USB connector arrangement, an Apple lightning connector arrangement, an 8-pin connector arrangement or the like as known in the art. The hermaphrodite power connector 160 includes may be further connected to a conductive charger via a second plug-and-socket connector, such as a mini-USB connector arrangement, a micro-USB connector arrangement, an Apple lightning connector arrangement, an 8-pin connector arrangement, 30-pin Apple connector, Thunderbolt connector, DC jack or the like as known in the art.

With this further embodiment, the secondary coil 120 is wired to the hermaphrodite power connector 160 including both a male plug 162 and a female socket 164. The male plug 162 of the hermaphrodite power connector 160 may be coupled to the power jack socket 220 of the device of a first plug-and-socket connector while still providing a female socket 164 for accommodating the plug 40 of a second plug-and-socket connector for use connecting to an external conductive charger. With this embodiment, a user may select between charging the power cells 340A of the mobile communication device 200A using the inductive charger interface 100A or the conductive type charger. The selection may be facilitated by means of a charger selection unit switch (not shown). Additionally or alternatively, the hermaphrodite power connector 160 may be configured to select automatically the inductive charger whenever the secondary coil 120 is inductively coupled to a primary coil 10 and to select the conductive power supply whenever the female socket 164 is conductively coupled to a power source.

Alternatively, in the embodiment shown in FIGS. 15A-C, the secondary coil 120 may be built into a protective or fashionable case 300 which may be fitted to a mobile communication device 200. The secondary coil 120 is typically wired to a hermaphrodite power connector 160 within the case 300 which is configured to couple with the power jack socket 220 of the mobile communication device.

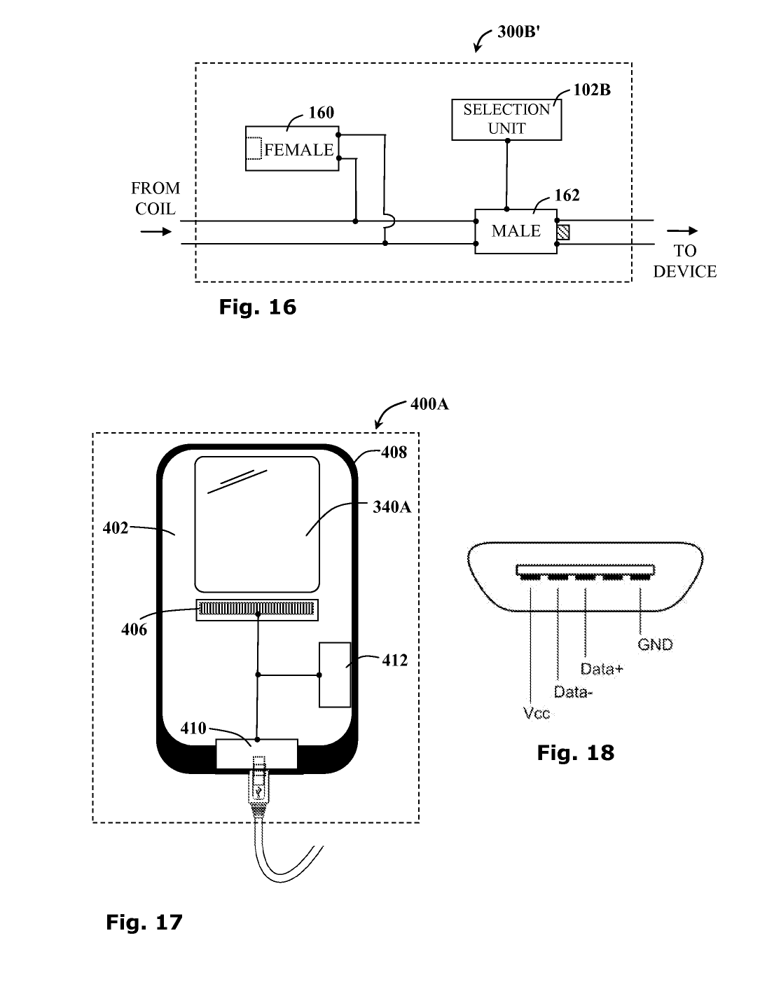

Reference is now made to the block diagram of FIG. 16 representing selected elements of another embodiment of a hermaphrodite power connector structure 300B′ supporting dual inductive charging functionality for a mobile communication device. The hermaphrodite power connector structure 300B′ may be configured to receive power directly from a conductive connection to a power supply such as the mains, a host computer, a vehicle power outlet or the like via a wired charger. Optionally, the connection may be controlled automatically by the unit selection control switch 102B.

It will be appreciated that the dual-mode functionality of the hermaphrodite power connector may be useful in combination with electrical devices which are configured and operable to receive charging power in different modes of operations, inductively or via a connected cable.

The hermaphrodite power connector structure 300B′ may include a female socket unit 164, a male connector unit 162 and a unit selection control switch 102B.

Accordingly the source of electrical power for charging the device may come directly from an external power supply such as the mains via a cable plugged into the female socket unit 164 or from the inductive coil of an inductive power transfer system. The unit selection control switch 102B may detect the power source and connect the electrical load to the appropriate circuitry as required. For example the unit selection control switch may be operable to connect the device to the female connector unit 160, when a conductive power source is detected, similarly the unit selection control switch 102B may be operable to connect the device to the inductive coil of the inductive power transfer system, when inductive power source is detected

It is noted that the charger selection unit 102B may switch the charging power coming from the secondary inductor 320A (FIG. 13B) and from the wired charger connector 204B (FIG. 13B).

Reference is now made to FIG. 17 showing a schematic illustration of a possible embodiment of a hosted electrical device configuration 400A, such as a mobile communication device for example, as a representation of dual-mode inductive charging and data exchange connectivity.

The hosted electrical device configuration 400A may include a hosted electrical device 402, such as a smartphone or tablet for example, having a chargeable battery 340A, a charging and data socket 406, encasement unit 408 having a Micro-USB connector socket 410 and a data connectivity unit 412 for data exchange purposes.

Accordingly, when the hosted electrical device 402 is inserted into the encasement unit 408 the plug connectivity to the integrated device for charging and data exchange may be used through a plug-and socket connector such as a mini-USB connector interface, a micro-USB connector interface or the like, for example. A USB connector is a 5 pins connector (see FIG. 18), may be used for various data exchange functions, such as connecting the electrical device represented by the 400A configuration with external headset to play music files, interfacing with a host computer for data exchange and the like.

Additionally or alternatively, data exchange functions may be performed by using short range radio frequency (RF) link such as Wi-Fi, Zigbee, NFC, Bluetooth or the like, such communication technologies with which communication devices may be equipped, avoiding the need to use the charging and data socket 406, for example.

Optionally, various proprietary or standard connectors may be used of independent manufacturers of chargeable devices 202B (FIG. 13B) associated with a variety of proprietary or standard charging voltages and communication protocols.

Optionally, the connectivity unit 410 may use known communication protocols such as WiFi, Bluetooth, Near Field Communication (NFC), and the like, or any other newly designed protocol loaded into this unit, thus enabling data transfer based on the new communication protocol.

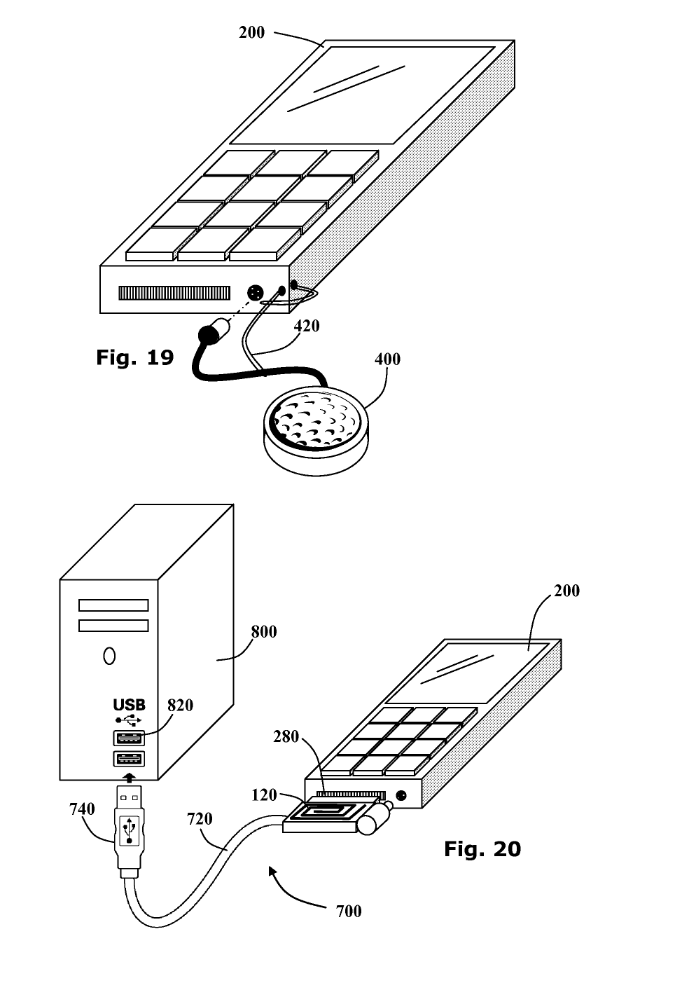

A further embodiment is illustrated in FIG. 19 showing a mobile communication device 200 having a secondary coil concealed within a fashionable tag 400, such as a so called “mobile dangler” or the like, which may be plugged directly into the power jack socket 220 with additional mechanical support 420 optionally provided when necessary. The inductive charger 100 of the invention may thus be incorporated within a fashion accessory for the mobile communication device. In a similar manner, the secondary coil 120 may be concealed in other accessories of the mobile telecommunication device such as a belt clip, neck cord, hand strap or the like.

According to still another embodiment, with reference to FIG. 20, an inductive charger 700 has a data channel coupled to the data jack socket 280 of the mobile communication device 200. A USB (Universal Serial Bus) cable 720 leading to a USB plug is wired to the inductive charger which may be connected to USB jack socket 820 of a computer 800, for example, thereby providing a data link between the mobile communication device 200 and the computer 800.

The USB connector 740 may, in addition, draw power from the computer 800 and may thus be used to provide power to charge the power cells 120 of the mobile communication device 200 directly. As described hereinabove with reference to the hermaphrodite connector, the charger 700 may be configured to select automatically between charging the power cells 120 from the USB connector 740 or the secondary coil 120 depending upon the availability of power.

U.S. Pat. No. 7,180,265 to Nokia Corporation, titled “Charging Device with an Induction Coil” describes an inductive charging device for charging portable electronic devices with small footprints. The charger described in '265 includes a battery; a first induction coil coupled to the battery; and an induction core extending through the first induction coil. The induction core has a portion which extends in an outward direction from the charging device and is adapted to removably couple with a second induction coil of a portable electronic device by extending into the second induction coil.

The charger described in '265 is essentially a charging hook upon which electronic devices may be suspended by support loops. The hook is coupled to the first inductive coil and is adapted to charge up the electronic devices via the secondary inductive coils which may be incorporated into the support loops. '265 claims to provide a convenient way to organize devices being charged. However, for some applications the support strap itself is undesirable, and as discussed hereinabove, there is a general desire to limit the number of wires, straps and cables.

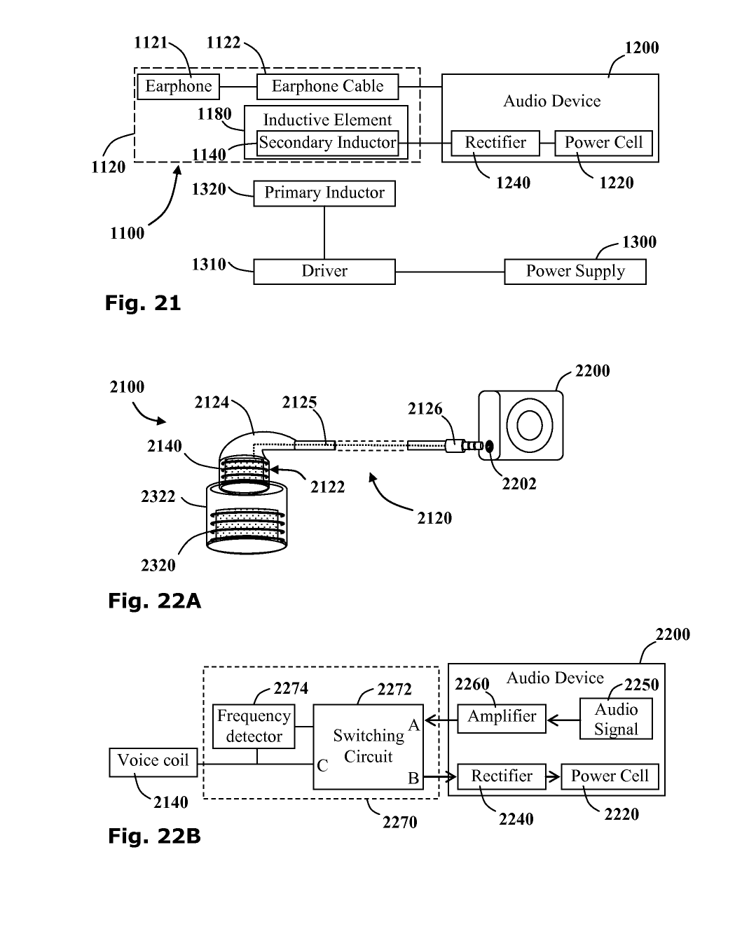

By way of example, referring now to FIG. 21, a block diagram showing the main elements of an inductive charger 1100 for charging the internal power cells 1220 of an audio device 1200, according to an embodiment of the invention.

The charger 1100 includes a secondary inductor 1140 wired to the power cells 1220 of the audio device 1200 via a rectifier 1240. An inductive element 1180 is incorporated into the earphone unit 1120 for inductively coupling the secondary inductor 1140 to an external primary inductor 1320.

The primary inductor 1320 is typically wired to a power supply 1300 via a driving unit 1310. The driving unit 1310 provides the electronics necessary to drive the primary inductor 1320, such as a switching unit providing a high frequency oscillating voltage supply, for example.

Charger 1100 is suitable for use with audio devices 1200 requiring earphones 1121 connected via earphone cables 1122 such as, telephones, media players, personal digital assistants (PDA), Walkman®s, portable CD players, portable DVD players, mobile communications devices and the like.

It is a particular feature of this embodiment, that at least a part of the inductive charger 1100 is incorporated in the earphone unit 1120 of the audio device 1200. This represents an advantage over prior art devices such as the system described in U.S. Pat. No. 7,164,255 to Hui, which disadvantageously requires a secondary winding to be incorporated either within the device itself or in a dedicated adaptor, whereas the inductive charger 1100 of the present invention is suitable for use in charging audio devices with small footprints. Furthermore, because the inductive charger 1100 of the present invention is incorporated into the earphone unit 1120, the dimensions of the audio device 1200 itself are not compromised by the addition of peripheral elements such as the support strap described in U.S. Pat. No. 7,180,265 to Nokia Corporation, for example.

With reference to FIG. 22A, a schematic diagram of a charger 2100 for an audio device 2200 according to another embodiment is shown. In this embodiment, the earphone unit 2120 includes a moving coil speaker 2122 incorporated within an earpiece 2124 which is connected via a signal line 2125 to a plug 2126 for coupling to the audio device 2200 via an earphone jack 2202. The voice coil 2140 of the moving coil speaker 2122 is a transducer that receives electrical signals from the signal lines 2125 and converts them to audio signals.

The voice coil 2140 is additionally configured to be coupleable to an external primary inductor 2320 which may be housed within a docking station 2322. Thus the voice coil 2140 may serve as the secondary inductor 1140 (FIG. 21) of the inductive charger 2100, providing power to the audio device via the signal lines 2125. Alternatively, dedicated power lines within the earphone unit 2120 may provide a conductive connection between the voice coil 2140 and the internal power cell 220 of the audio device 200 via a rectifier 1240 (FIG. 21).

FIG. 22B is a block diagram of the main elements of a switching unit 2270 for connecting the charger 2100 of FIG. 22A to an audio device 2200. The switching unit 2270 is provided to selectively connect the voice coil 2140 to the audio device 2200. The switching unit 2270 may be a separate unit that is retrofittable both to the audio device 2200 and to the earphone unit 2120. Alternatively, the switching unit 2270 may be incorporated into either the audio device 2200 or the earphone unit 2120.

The switching unit 2270 may connect the voice coil terminal C to either an audio signal input A or to a charger output B of a switching circuit 2272. The audio signal input A receives an audio signal 2250 from an amplifier 2260 which is communicated to the voice coil 2140. The charger output B is connected to the power cell 2220 via a rectifier 2240 and may be used for charging the power cell 2220 when the voice coil 2140 is coupled to primary inductor 2320.

Optionally the switching circuit 2272 may be controlled by a frequency detector 2274 which is configured and operable to detect high frequency voltage fluctuations along the signal line. High frequency voltage fluctuations are indicative that the voice coil 2140 is coupled to an active primary inductor 2320 (FIG. 22A). Therefore, when such high frequency fluctuations are detected, the switching circuit 2272 may be connected to the charger output B for charging the power cell 2220.

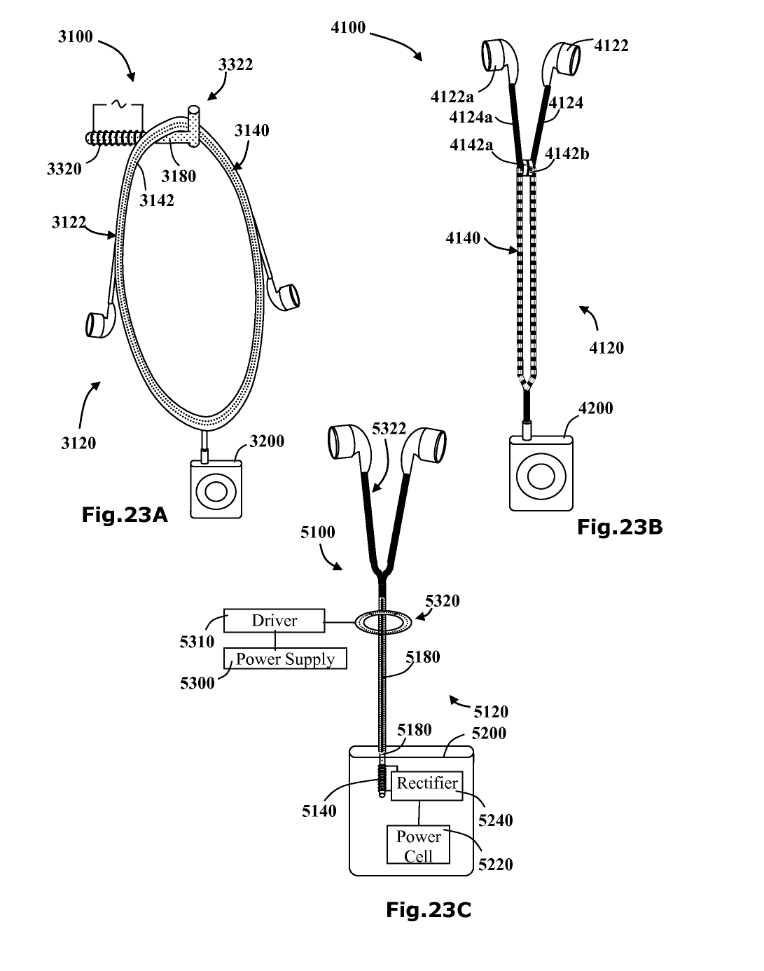

FIGS. 23A-C are schematic diagrams showing various embodiments of charger 3100, 4100, 5100 for an audio device 3200, 4200, 5200. With reference to FIG. 23A, the earphone unit 3120 includes a neck support 3122. Within the neck support 3122 is an induction loop 3140 of conductive wire 3142 that is wound into a coil and connected to the internal power cell 1220 (FIG. 21) of the audio device 3200 via a rectifier 1240 (FIG. 21). The inductive loop 3140 is configured to inductively couple with an external primary inductor 320. The audio device 3200 may be conveniently stored by suspending the neck support 3122 from a hook 3322.

In preferred embodiments, the hook 3322 is fabricated from a ferromagnetic material which extends through a primary coil 3320. When the neck support 3122 is suspended from the hook 3322, the ferromagnetic material forms a common inductive core 3180 between the primary coil 3320 and the inductive loop 3140 within the neck support 3122. The primary coil 3320 and inductive loop 3140 thus form an inductive couple such that power may be inductively transferred from the primary coil 3320 to the inductive loop 3140, thereby charging the power cells 1220 (FIG. 21) of the audio device 3200.

Optionally, the inductive couple may be improved by the inclusion of a ferromagnetic element (not shown) and may be incorporated into the neck support 3122 and configured so as to couple with the ferromagnetic inductive core 3180 of the hook 3322 so as to complete a magnetic circuit.

Although the example of an inductive loop 3140 within a neck support 3122 is described herein, it is noted that a secondary inductor may be housed in various other components of an earphone unit. For example a secondary induction coil may be housed in a dedicated unit within the earphone cable. Alternatively a secondary coil may be incorporated into a microphone housing such as is commonly included in the earphone cable of a cellular telephone. Alternatively again a secondary coil may be incorporated into a cable stowage unit such as a spring loaded winder as is sometimes included with earphone units for convenient storage.

An alternative embodiment of the induction loop is schematically represented in FIG. 23B, wherein a charger 4100 for an audio device 4200 according to another embodiment of the current invention is shown. The earphone unit 4120 of this embodiment includes two earpieces 4122a, 4122b, each connected to the audio device 4200 via its own earphone cable 4124a, 4124b. A bundle of induction wires 4140, embedded in the earphone cables 4124, is connected to the internal power cell 1220 (FIG. 21) of the audio device 4200 via the rectifier 1240 (FIG. 21). Contact-terminals 4142a and 4142b at each end of the bundle of induction wires 4140, typically located near the earpieces 4122a, 4122b, are configured to conductively couple the ends of the bundle of induction wires 4140 thereby forming an induction loop. The induction loop may be coupled with an external primary coil (not shown) such that power may be inductively transferred from the primary coil to the inductive loop.

FIG. 23C is a schematic representation of a charger 5100 for an audio device 5200 according to still another embodiment of the invention. The audio device 5200 incorporates an internal secondary coil 5140 connected to the internal power cell 5220 via the rectifier 5240. An inductive core 5180 extends through the internal secondary coil 5140 and into the earphone unit 5120 for coupling with a primary inductor 5320. The primary inductor may, for example, be incorporated into a hook (not shown) for suspending the audio device 5200.

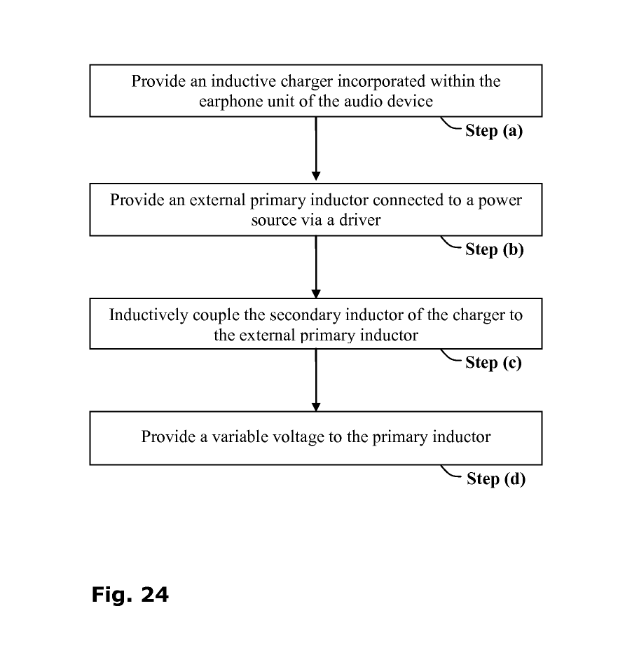

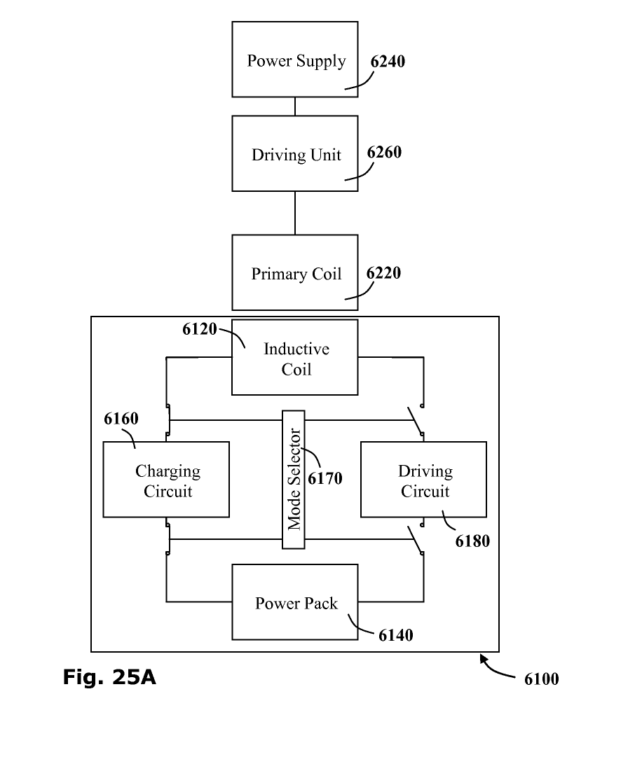

FIG. 24 is a flowchart showing a method for inductively charging the internal power cell of an audio device in accordance with one embodiment of the invention. The method comprises the steps of:

providing an inductive charger incorporated within the earphone unit of the audio device, including a secondary inductor connected to the power cell via a rectifier;

providing an external primary inductor connected to a power source via a driver;

inductively coupling the secondary inductor of the charger to the external primary inductor, and

providing a variable voltage to the primary inductor.

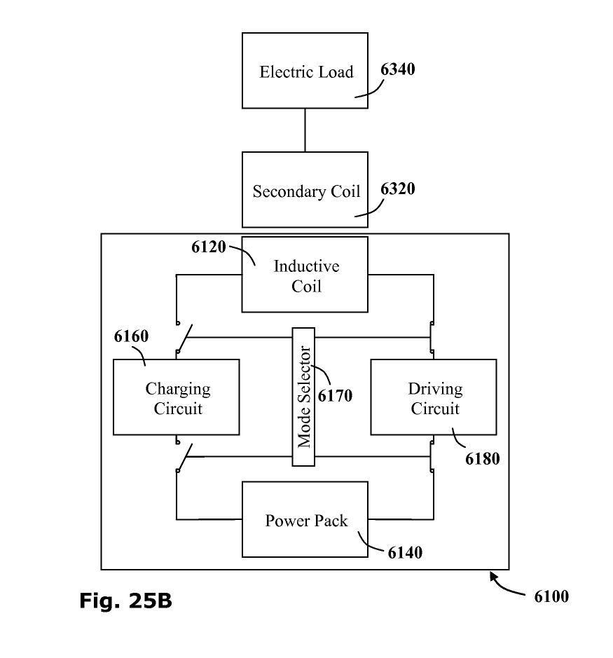

Reference is now made to FIGS. 21a and 21b which are block diagrams schematically representing the inductive charger 6100 for use with another embodiment of the invention. The inductive charger 6100 consists of an inductive coil 6120 and a chargeable power pack 6140 which can be connected to each other via a charging circuit 6160 or alternatively via a driving circuit 6180. It is a particular feature of the current invention that the inductive charger 6100 may be switched between two modes: (a) a charging mode as shown in FIG. 25A, and (b) a driving mode, as shown in FIG. 25B. A mode selector 6170 is used to select between the two modes.

With particular reference to FIG. 25A, representing the inductive charger 6100 in charging mode, the inductive coil 6120 is coupled to an external primary inductive coil 6220 which is connected to a power supply 6240 preferably via a driving unit 6260. The mode selector 6170 is configured to connect the inductive coil 6120 to the power pack 6140 via the charging circuit 6160.

In the charging mode, the external primary coil 6220 generates an oscillating magnetic field. The internal inductive coil 6120 is placed in the vicinity of the external primary coil 6220, thereby creating a magnetic flux linkage between the primary coil 6220 and the internal inductive coil 6120, by which power is transferred from the external primary coil 6220 to the internal inductive coil 6120. Typically, direct current is required for reversing the electrochemical reactions that result in power supply from the power packs and the charging circuit 6160 rectifies the alternating current generated in the inductive coil 6120 thereby allowing the power pack 6140 to be recharged.

Referring now to FIG. 25B, representing the inductive charger 6100 in driving mode, where the inductive coil 6120 is inductively coupled to an external secondary inductive coil 6320 which is wired to an electric load 6340. The mode selector 6170 is configured to connect the inductive coil 6120 to the power pack 6140 via the driving circuit 6180. In the driving mode the power supply 6140 provides power to the driver circuit 6180 which provides a varying electrical potential to drive the inductive coil 6120. The driver circuit 6180 typically includes a high frequency switching unit intermittently connecting the power pack 6140 to the inductive coil 6120. The varying electrical potential across the inductive coil 6120 produces an oscillating magnetic field. Therefore, an external secondary coil 6320 which is brought into the vicinity of the inductive charger 6100 may inductively couple with the inductive coil 6120. An electric load 6340 wired to the secondary coil 6320 may thereby draw power from the power pack 6140.

Many examples of rechargeable power packs are known and may be suitable for use with various embodiments of the inductive charger 6100. Examples of rechargeable electrochemical cells include nickel-cadmium cells, nickel metal hydride cells, alkaline cells, flow batteries and the like. Other power storage devices such as lead alkali accumulators, capacitors and supercapacitors may also be charged by the inductive charger 6100.

Reference is now made to FIGS. 22a and 22b showing an exemplary inductive charger 7100 according to another embodiment of the invention. A housing 7110 contains an inductive coil 7120 which is wrapped around a ferromagnetic core 7122 and is connected to an internal power pack 7140 via a control box 7130. The control box 7130 contains driving circuitry for the driving mode, charging circuitry for the charging mode and a mode selector (not shown). In alternative embodiments (not shown), additional circuitry may be provided for charging the power pack 7140 from the mains or other external power source, such as solar power or the like, via a dedicated jack. A dedicated jack may also be provided for conductively connecting with and the powering of an external electrical load.

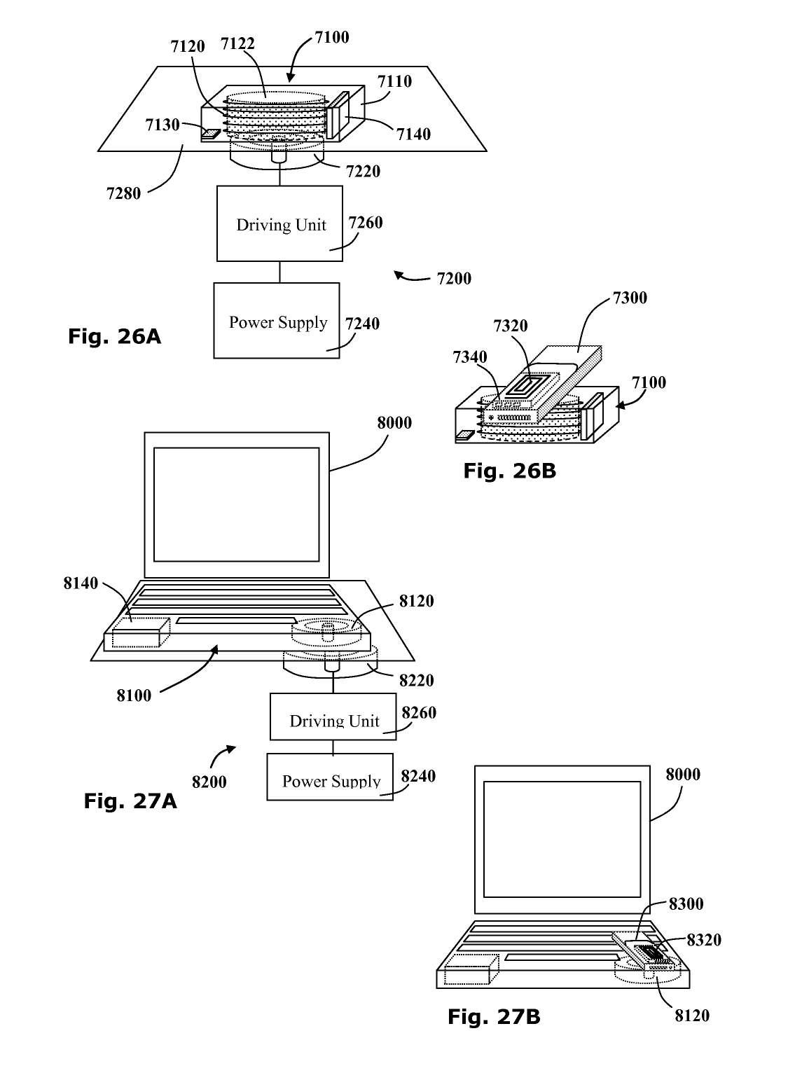

FIG. 26A shows the inductive charger 7100 being charged up by an inductive power outlet 7200 which consists of a primary coil 7220 concealed behind a facing layer, such as Formica or wood veneer, of a platform 7280 such as a desk-top, a kitchen work-top, a conference table or a work bench for example. The primary coil 7220 is wired to a power supply 7240 via a driving unit 7260 providing the electronics necessary to drive the primary coil 7120. Driving electronics may include a switching unit providing a high frequency oscillating voltage supply, for example.

As inductive power outlets 7200 become more widespread, it is considered likely that devices may be hardwired to secondary coils, to draw their power inductively therefrom. In particular, mobile phones, media players and the like which are generally connected to external chargers via connecting wires may be provided with internal charging circuitry that includes a secondary coil for inductively coupling to inductive power outlet 7200.

FIG. 26B shows a mobile phone 7300 which has an integral secondary inductive coil 7320 connected to its internal power source 7340 via a rectifier (not shown). The mobile phone 7300 may be charged by placing it over an inductive power outlet 7200 such as shown in FIG. 26A, thereby inductively coupling the secondary coil 7320 of the device with the primary coil of the outlet 7200.

Where no inductive power outlet 7200 is available, the mobile phone may be charged by placing it on top of the inductive charger 7100, as shown in FIG. 7B. With the inductive charger 7100 set to driving mode, the mobile phones secondary coil 7320 inductively couples with the internal inductive coil 7120 of the inductive charger 7100 and draws power therefrom.

According to another embodiment of the inductive charger, shown in FIGS. 27A and 27B, the inductive charger 8100 is incorporated into a mobile computer 8000. The mobile computer 8000 has a built-in inductive coil 8120 for powering the computer from an inductive power outlet 8200, as shown in FIG. 27A. Once coupled to a primary coil 8220, the inductive coil 8120 may power the computer and/or charge the internal power pack 8140 of the mobile computer.

The inductive coil 8120 of the computer 8000 may additionally be used to charge an external device such as a mobile phone 8300 with an in-built secondary coil 8320, as shown in FIG. 8B. A similar use is already made of computers 8000 to charge external devices such as media players, mobile phones, mice, Bluetooth devices and the like, generally using dedicated cables and via standard ports, such as their USB (universal serial bus) ports. One advantage of this is that no such dedicated cables are needed.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims.

Additionally, the various embodiments set forth hereinabove are described in term of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A multi-mode power transfer system for providing power to an electrical device, comprising:
said electrical device;
a wired power connector; and
a wireless power receiver unit comprising:
a wireless power receiving element; and
a selection control switch,
wherein said selection control switch is configured to switch between:
a wired power transfer mode wherein said wired power connector is electrically connected to said electrical device, and
a wireless power transfer mode wherein said wireless power receiver is electrically connected to said electrical device.

2. The multi-mode power transfer system of claim 1 wherein said wireless power receiver comprises a secondary inductor, for inductively coupling with a primary inductor wired to a power supply.

3. The multi-mode power transfer system of claim 1, wherein said wireless power receiver unit is connected to the electrical device via a first plug-and-socket connector selected from a group consisting of: a mini-USB connector arrangement, a micro-USB connector arrangement, an Apple lightning connector arrangement, an 8-pin connector.

4. The multi-mode power transfer system of claim 1, wherein said wired power connector comprises a second plug-and-socket connector selected from a group consisting of: a mini-USB connector arrangement, a micro-USB connector arrangement, an Apple lightning connector arrangement, an 8-pin connector arrangement, 30-pin Apple connector, Thunderbolt connector and a DC jack.

5. The multi-mode power transfer system of claim 1, wherein said wired power connector is further operable to connect with a data exchange mechanism such that data is exchangeable between an external device and said electrical device.

6. The multi-mode power transfer system of claim 5, wherein said data exchange mechanism is configured to use a short range radio frequency link, said radio frequency link is selected from a group consisting of: Wi-Fi, Bluetooth, Near Field Communication, Zigbee and combinations thereof.

7. The multi-mode power transfer system of claim 5, wherein said data exchange mechanism uses a plug-and socket connector selected from a group consisting of a mini-USB connector, a micro-USB connector interface and vendor proprietary connector.

8. A wireless power receiver unit for connecting to an electrical device, said wireless power receiver unit comprising:
a wireless power receiving element;
a first connector configured to connect with a power connector of said electrical device;
a second connector configured to connect with a connector of a wired external power source; and
a selection control switch;
wherein said selection control switch is configured to switch between:
a wired power transfer mode wherein said first connector is electrically connected to said second connector, and
a wireless power transfer mode wherein said first connector is connected to said wireless power receiving element.

9. The wireless power receiver unit of claim 8 wherein said wireless power receiver [receiving element] comprises a secondary inductor, for inductively coupling with a primary inductor wired to a power supply.

10. The wireless power receiver unit of claim 8 wherein said first connector comprises a male plug connector configured to connect with a female power connector socket connector of said electrical device.

11. The wireless power receiver unit of claim 8 wherein said second connector comprises a female socket connector configured to connect with a male plug connector socket connector of said wired external power source.

12. The wireless power receiver unit of claim 8, wherein said switching is performed automatically.

13. The wireless power receiver unit of claim 8, wherein said wherein said switching is performed manually.

14. The wireless power receiver unit of claim 8, wherein said first connector is selected from a group consisting of: a mini-USB connector arrangement, a micro-USB connector arrangement, an Apple lightning connector arrangement, an 8-pin connector.

15. The wireless power receiver unit of claim 8, wherein said second connector is selected from a group consisting of: a mini-USB connector arrangement, a micro-USB connector arrangement, an Apple lightning connector arrangement, an 8-pin connector arrangement, a 30-pin Apple connector, Thunderbolt connector and a DC jack.

16. The wireless power receiver unit of claim 8, wherein said wired external power source is a wired charger powered by a power supply, said power supply is selected from a group consisting of mains power supply, a host computer and a vehicle power outlet.

17. The wireless power receiver unit of claim 16, wherein said second connector is further connectable to a USB plug for coupling to a USB power socket such that said electrochemical cell is selectably chargeable and power is drawn from said USB power socket or used for data exchanging between an external device and said electrical device.
